(19) United States
(12) Patent Application Publication
(10) Pub. No.: US 2017/0109350 A1
(43) Pub. Date: Apr. 20, 2017

(54) MENU DISPLAYING METHOD, MENU DISPLAYING DEVICE

(71) Applicant: FUJITSU LIMITED, Kawasaki-shi (JP)

(72) Inventors: KENICHI NAGANO, Fukuoka (JP); Shinya Mizuho, Fukuoka (JP); Teppei KAKUMOTO, Fukuoka (JP); RYOUSUKE NONAKA, Fukuoka (JP); Satoshi Nakamura, Fukuoka (JP); Hiroshi SEKIYA, Fukuoka (JP); Koji Tsuruta, Fukuoka (JP); Keiko Goto, Ota (JP)

(73) Assignee: FUJITSU LIMITED, Kawasaki-shi (JP)

(21) Appl. No.: 15/270,176

(22) Filed: Sep. 20, 2016

(30) Foreign Application Priority Data
Oct. 16, 2015 (JP) 2015-205022

(51) Int. Cl. G06F 17/30

(52) U.S. Cl. CPC G06F 17/3028; G06F 17/30268; G06F 17/30528; G06F 17/30554; G06F 17/30867

(57) ABSTRACT

The server receives allergy information. The server controls whether a photograph or an illustration of a product is not displayed in correlation with a name of the product to be displayed on the basis of whether the product includes an allergen corresponding to the allergy information.

### CROSS-REFERENCE TO RELATED APPLICATION(S)

This application is based upon and claims the benefit of priority of the prior Japanese Patent Application No. 2015-205022, filed on Oct. 16, 2015, the entire contents of which are incorporated herein by reference.

### FIELD

The embodiments discussed herein are related to a display method and the like.

### BACKGROUND

Recently, the number of persons having a food allergy has increased with a change of diet or the like. The Consumer Affairs Agency, Government of Japan requests food companies, restaurants, or the like to disclose information on principal allergic substance so as not to harm patients' health having a food allergy.

Accordingly, restaurants take, measures of describing information of allergic substance included in dishes in correlation with dish names of a menu so as to respond to the request of the Consumer Affairs Agency, Government of Japan. When a patient having an allergy eats out in a restaurant, the patient checks information of allergic substance of dishes described in a menu and chooses a dish not causing an allergy. These related-art examples are described, for example, in Japanese Laid-open Patent Publication No, 2005-202763, Japanese Laid-open Patent Publication Mo. 2005-222191,International Publication Pamphlet No. WO 2001/095185 and Japanese Laid-open Patent Publication No. 2014-120126.

In conventional technology, there is a problem in that it is not possible to display a menu based on allergy information.

For example, a process of checking information of allergic substance of dishes described in a menu one by one and choosing a dish requires time and increases a burden of a patient or the patient's companion. In some restaurants, a recommended dish may be displayed in a menu with a photograph. In some cases, a dish which is specially desired to be eaten by customers, such as an in-season menu or a new menu is displayed more conspicuously than other dishes. FIG. 12 is a diagram illustrating an example of a menu in the related art. In the example illustrated in FIG. 12, “special rice omelet” is displayed as a recommended dish. This display of a menu is effective for general customers, but a customer who has an allergy to egg and does not eat the recommended dish may foe depressed at such a menu.

### SUMMARY

According to an aspect of an embodiment, a menu displaying method includes receiving allergy information; and controlling whether a photograph or an illustration of a product is not displayed in correlation with a name of the product to be displayed on the basis of whether the product includes an allergen corresponding to the allergy information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a system according to an embodiment,

FIG. 2 is a diagram illustrating an example of a menu screen which is generated by a server when a companion is “present”;

FIG. 3 is a diagram illustrating an example of a menu screen which is generated by the server when a companion is “not present”;

FIG. 4 is a functional block diagram illustrating a configuration of a server according to the embodiment;

FIG. 5 is a diagram illustrating an example of a data structure of an allergy information table;

FIG. 6 is a diagram illustrating an example of a data structure of a menu table;

FIG. 7 is a diagram illustrating an example of a data structure of a user management table;

FIG. 8 is a diagram illustrating an example of a display screen of a tablet terminal

FIG. 9 is a flowchart (1) illustrating a process flow of a server according to the embodiment;

FIG. 10 is a flowchart (2) illustrating a process flow of the server according to the embodiment;

FIG. 11 is a diagram illustrating an example of a computer that executes a computer-readable recording medium; and

FIG. 12 is a diagram illustrating an example of a menu in the related art.

### DESCRIPTION OF EMBODIMENTS

In conventional technology,, there is a problem in that it is not possible to display a menu based on allergy information.

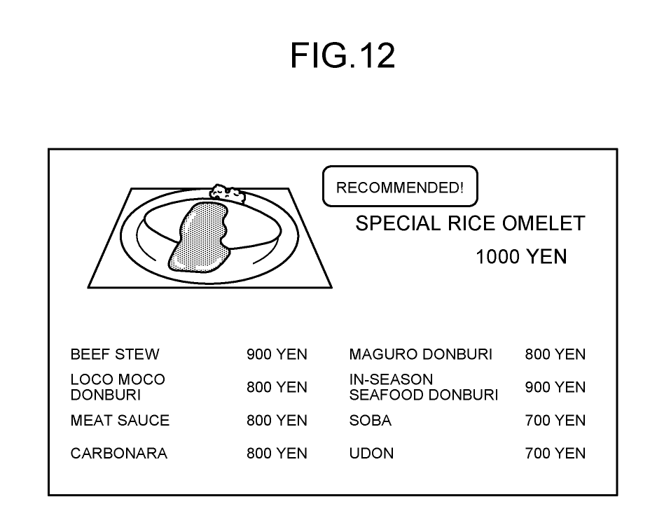

For example, a process of checking information of allergic substance of dishes described in a menu one by one and choosing a dish requires time and increases a burden of a patient or the patient's companion. In some restaurants, a recommended dish may be displayed in a menu with a photograph. In some cases, a dish which is specially desired to be eaten by customers, such as an in-season menu or a new menu is displayed more conspicuously than other dishes. FIG. 12 is a diagram illustrating an example of a menu in the relate, art. In the example illustrated in FIG. 12, “special rice omelet” is displayed as a recommended dish. This display of a menu is effective for general customers, but a customer who has an allergy to egg and does not eat the recommended dish may foe depressed at such a menu.

Preferred embodiments of the present invention will be explained with reference to accompanying drawings. The present invention is not limited to the embodiments.

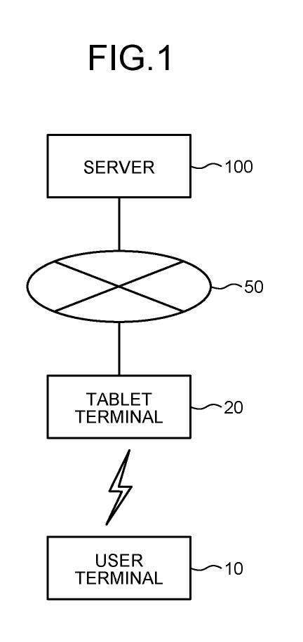

FIG. 1 is a diagram illustrating a configuration of a system according to an embodiment. As illustrated in FIG. 1, the system includes a user terminal 10, a tablet terminal 20, and a server 100. The server 100 is an example of a display device. For example, the server 100 and the tablet terminal 20 are connected to each other via a network 50. The tablet terminal 20 and the user terminal 10 perform data communication with each other in a wireless manner.

The user terminal 10 is a terminal device that is carried by a user and corresponds to, for example, a smartphone. The user terminal 10 stores allergy information. For example, the allergy information is information in which user identification data (ID) and allergic substance are correlated with each other. The user ID is information for uniquely identifying a user. The allergic substance is an allergen to which a user identified, by the user ID has an allergy.

The tablet terminal 20 is a tablet terminal that displays a menu screen on the basis of menu screen information transmitted from the server 100. The tablet terminal 20 communicates with the user terminal 10 in a wireless manner to acquire allergy information from the user terminal 10 and transmits the acquired allergy information to the server 100. The tablet terminal 20 receives an input of information on whether a companion is present from a user and transmits the received information on whether a companion is present to the server 100.

Although not illustrated in the drawing, plural tablet terminals 20 are present and are disposed in tables of restaurants and the like. For example, a table ID for uniquely identifying a table in which the tablet terminal is disposed is allocated to the tablet, terminal 20. The tablet terminal 20 transmits the allergy information or the information on whether a companion is present to the server 100 in correlation with the table ID.

When receiving an input indicating that a user having an allergy is not present, the tablet terminal 20 transmits information indicating that a user having an allergy is not present to the server 100 in correlation with the table ID.

The server 100 is a device that generates menu screen information on the basis of the allergy information and the information on whether a companion is present. The server 100 transmits the generated menu screen information to the tablet terminal 20 to display a menu screen.

For example, the menu screen includes a first area and a second area. The first area is an area in which dish names are displayed with photographs or illustrations. The second area is an area in which dish names are displayed without any photograph or illustration.

When a user having an allergy is not present, the server 100 sets the first area to display dish names from a dish name having highest priority with photographs or illustrations with reference to menu information. On the other hand, when a user having an allergy is present, the server 100 sets the first area to display dish names of dishes not containing allergic substance corresponding to the user's allergy information from the dish name having highest priority with photographs or illustrations regardless of a companion.

When a companion is “present,” the server 100 sets the second area to display dish names of dishes containing the allergic substance corresponding to the allergy information and dish names of dishes not containing the allergic substance corresponding to the allergy information. On the other hand, when a companion is “not present,” the server 100 sets the second area to display dish names of dishes not containing the allergic substance corresponding to the allergy information.

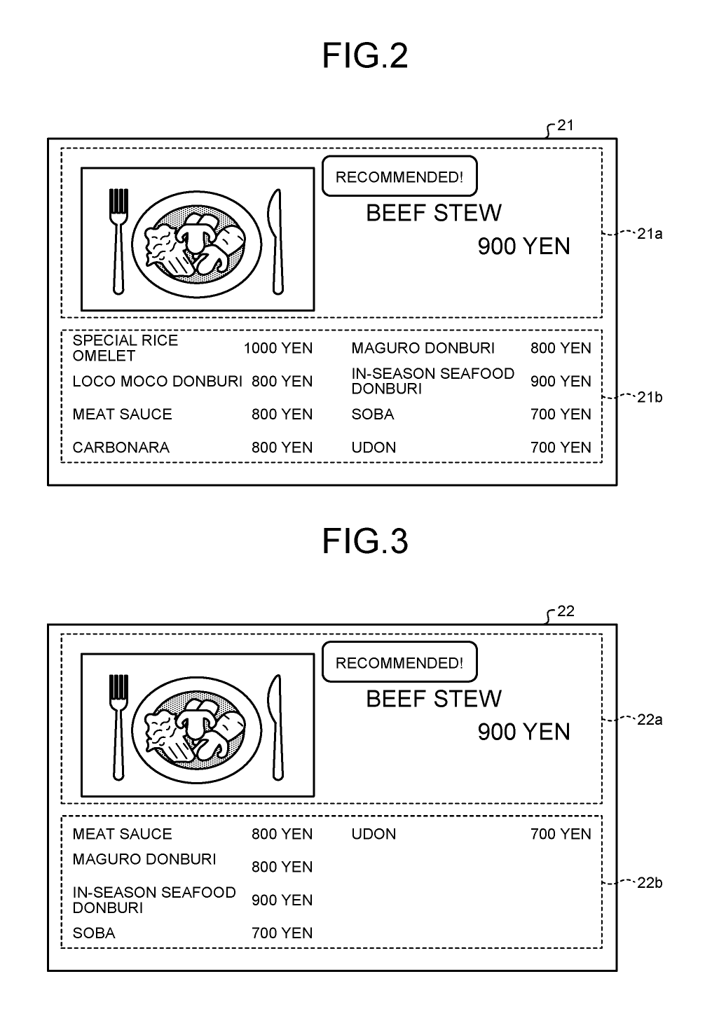

FIG. 2 is a diagram illustrating an example of a menu screen which is generated by the server when a companion is “present.” For example, it is assumed that a user's allergic substance is “egg.” In a menu screen 21 illustrated in FIG. 2, an area 21a corresponds to the first area and an area 21b corresponds to the second area. The server 100 acquires an illustration and a dish name to be displayed in the area 21a with reference to a menu table illustrated, in FIG. 6. Here, among dishes not containing the allergic substance “egg,” an illustration and a dish name of “beef stew” having high priority are arranged. The server 100 displays a normal menu (not illustrated) which is not set as a recommended menu in the area 21b. Here, since a companion is “present,” dish names oil dishes containing the allergic substance “egg” and dishes not containing the allergic substance are arranged.

For example, recommended dishes can be introduced to a customer from a restaurant when the server 100 causes the tablet terminal 20 to display the menu screen 21 illustrated in FIG. 2, Since dishes not containing the user's allergic substance among the recommended dishes can be introduced as recommended dishes as well as simple introduction of the recommended dishes, it may be possible to prevent the user having an allergy from being depressed because the user does not eat the recommended dishes. When the user having an allergy has a companion, it may be possible to prevent the companion from not selecting dishes containing the user's allergic substance by displaying the dishes together.

FIG. 3 is a diagram illustrating an example of the menu screen which is generated by the server when a companion is “not present.” For example, it is assumed that a user's allergic substance is “egg.” In a menu screen 22 illustrated in FIG. 3, an area 22a corresponds to the first area and an area 22b corresponds to the second area. The server 100 arranges an illustration and a dish name of a dish “beef stew” not containing the allergic substance “egg” in the area 22a. The server 100 arranges a dish name of a dish not containing the allergic substance “egg” in the area 22b. For example, since the server 100 can introduce only dishes not containing the user's allergic substance by causing the tablet terminal 20 to display the menu screen 22 illustrated in FIG. 3, it is possible to prevent the user front being depressed at the dish which the user does not eat or to suppress a burden of selecting a dish while checking whether an allergic substance is contained in the dish.

Although not illustrated in FIGS. 2 and 3, the server 100 may arrange information of the allergic substance contained in a dish together with each dish name.

When information indicating that a user having an allergy is not present is received from the tablet terminal 20, the server 100 transmits information of a normal menu screen illustrated in FIG. 12 to the tablet terminal 20 to display the normal menu screen.

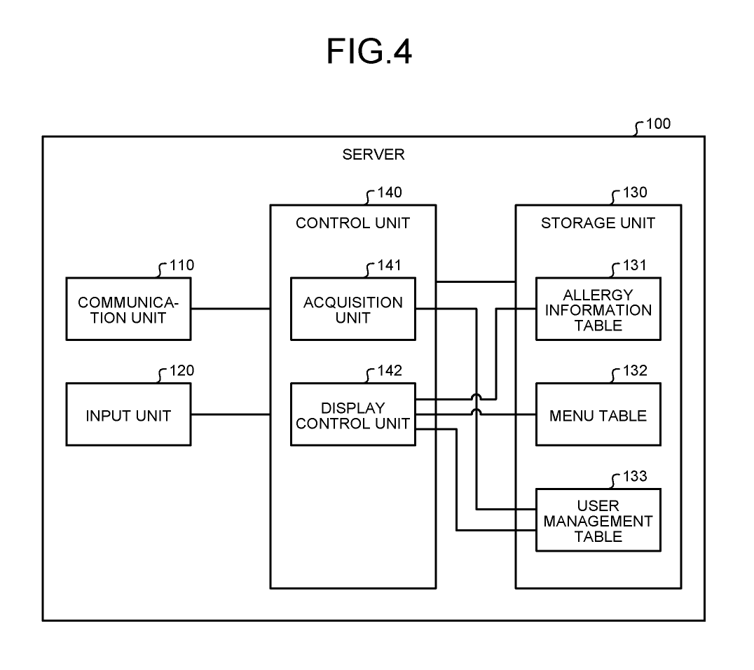

The configuration of the server 100 illustrated in FIG. 1 will be described below. FIG. 4 is a functional block diagram illustrating the configuration of the server according to this embodiment. As illustrated in FIG. 4, the server 100 includes a communication unit 110, an input unit 120, a storage unit 130, and a control unit 140.

The communication unit 110 is a processor that performs data communication with the tablet terminal 20 via the network 50. The communication unit 110 corresponds to a communication device. The control unit 140 to be described later exchanges data with the tablet terminal 20 via the communication unit 110.

The input unit 120 is an input device for inputting a variety of information to the server 100. For example, the input unit 120 corresponds to a keyboard, a mouse, a touch panel, an input button, or the like.

The storage unit 130 includes an allergy information table 131, a menu table 132, and a user management table 133. The storage unit 130 corresponds to a storage device of a semiconductor memory device such as a random access memory (RAM), a read only memory (ROM), or a flash memory.

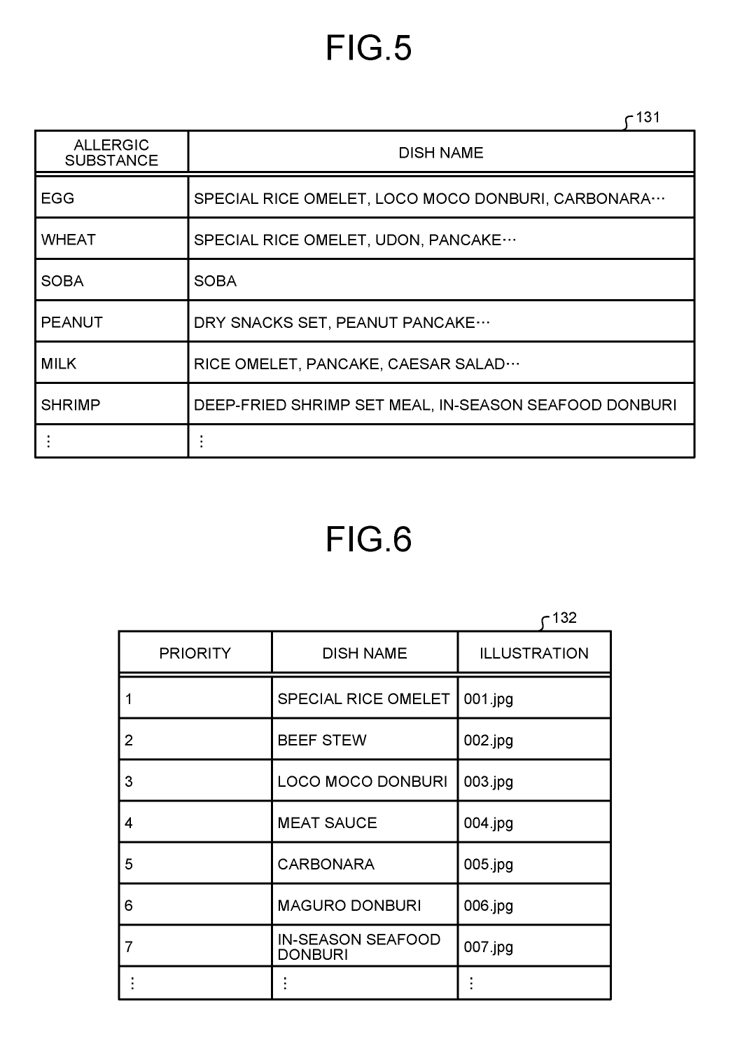

The allergy information table 131 is a table in which information of allergic substance contained in dishes is stored. FIG. 5 is a diagram illustrating an example of a data structure of the allergy information table. As illustrated in FIG. 5, the allergy information table 131 correlates allergy substance with dish names. For example, a record of a first row in FIG. 5 indicates that dish names of dishes containing the allergic substance “egg” are “special rice omelet, loco moco donburi, carbonara, . . . . ”

The menu table 132 is a table in which information of dishes to be displayed in the first area of the menu screen is stored. FIG. 6 is a diagram illustrating an example of a data structure of the menu table. As illustrated in FIG. 6, the menu table 132 correlates priority, dish names, and illustrates with each other. The priority indicates priority levels of dishes to be displayed in the first area of the menu screen as recommended dishes, and represents that the smaller the value becomes, the higher the priority level becomes. The dish name is appellation of dishes. The illustration is image data of illustrations of the corresponding dishes. Here, the menu table 132 stores illustrates of dishes, but may store photographs thereof instead of the illustrations.

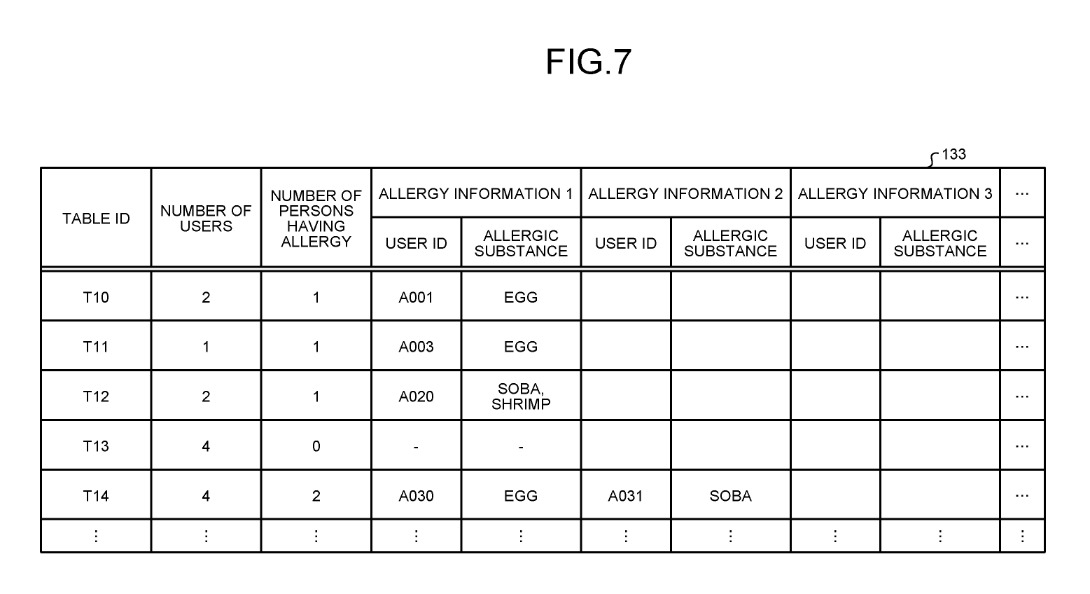

The user management table 133 is a table in which information on whether allergic substance causing allergic symptoms for a user or a companion is present is stored. FIG. 7 is a diagram illustrating an example of a data structure of the user management table. As illustrated in FIG. 7, the user management table 133 correlates table IDs, the number of users, the number of persons having an allergy, and allergy information with each other. Among these, the table ID is information for uniquely identifying a table in which the tablet terminal 20 is disposed. The number of users indicates the number of users sitting at the same table. The number of persons having an allergy indicates the number of users having an allergy among the users. The allergy information correlates user IDs with allergic substance. The user ID is information for uniquely identifying a user having an allergy. The allergic substance is information indicating allergic substance causing an allergic symptom for the user corresponding to the user ID.

For example, a record in a first row in the user management table 133 will be described. In a table with a table ID “T10”, “2” as the number of users, “1” as the number of persons having an allergy, and a user with a user ID “A001” and allergic substance “egg” of the user with the user ID “A001” as the allergy information I are registered,

When a user having an allergy is not present, the number of users is set to the number of visitors and the number of persons having an allergy is set to “0.” As the allergy information, the user ID and the information on the allergic substance are set to “-”. For example, as for users using a. table with a table ID “T13” in FIG. 7, since there is no user having an allergy, the user ID and the information on the allergic substance are set to “-”. In this way, it is determined whether a user's companion is present on the basis of the number of users and the number of persons having an allergy. As well as determination based on the number of users, a user may be made to set whether a companion is present.

Description will continue with reference to FIG. 4. The control unit 140 includes an acquisition unit 141 and a display control unit 142. The control unit 140 corresponds to an integrated circuit such as an application specific integrated circuit (ASIC) or a field programmable gate array (FPGA). The control unit 140 corresponds to an electronic circuit such as a central processing unit (CPU) or a micro processing unit (MPU).

The acquisition unit 141 is a processor that acquires information of the number of users, the number of persons having an allergy, and the allergy information from the tablet terminal 20. For example, it is assumed that the table ID in which the tablet terminal 20 is disposed is allocated to the allergy information and the information on whether a companion is present.

The acquisition unit 141 registers the user ID and the allergic substance included in the allergy information in the user management table 133 using the table ID as a key. The acquisition unit 141 registers the information on whether a companion is present in the user management table 133 using the table ID as a key.

When information indicating that a user having an allergy is not present is acquired from the tablet terminal 20, the acquisition unit 141 sets the user ID and the information on the allergic substance corresponding to the table ID in the user management table 133 to “-”.

The display control unit 142 is a processor that generates information of the menu screen which is displayed by the tablet terminal 20 on the basis of the allergy information table 131, the menu table 132, and the user management table 133. For example, the display control unit 142 generates information of the menu screen for each table ID and transmits the information of the menu screen to the tablet terminal corresponding to the table ID. Hereinafter, an example of a process which is performed by the display control unit 142 will be described. The display control unit 142 performs a process of specifying information of dishes which are arranged in the first area of the menu screen and a process of specifying information of dishes which are arranged in the second area of the menu screen.

An example of the process of specifying the information of dishes which are arranged in the first area of the menu screen, which is performed by the display control unit 142, will be described below. The display control unit 142 selects a table ID of the user management table 133 and specifies allergic substance contained in the selected table ID. The display control unit 142 compares the specified allergic substance with the allergy information table 131 and the menu table 132 and specifies a dish name and an illustration having a highest priority level among the dish names not containing the specified allergic substance. The display control unit 142 arranges the dish name and the illustration in the first area of the menu screen.

For example, a case in which a dish name and an illustration to foe arranged in the first area of the menu screen with a table ID “T10” will be described below. As illustrated in FIG. 7, the allergic substance corresponding to the table ID “T10” is “egg.” The display control unit 142 compares the allergic substance “egg” with the allergy information table 131 and specifies dish names of dishes containing the allergic substance “egg,” As illustrated in FIG. 5, the dish names of the dishes containing the allergic substance “egg” include “special rice omelet, loco moco donburi, carbonara, . . . .”

The display control unit 142 compares the dish names “special rice omelet, loco moco donburi, carbonara, . . . ” of the dishes containing the allergic substance “egg” with the dish names of the menu table 132. The display control unit 142 acquires an illustration of a dish name “beef stew” having a highest priority level from the menu table 132 among the dish names other than “special rice omelet, loco moco donburi, carbonara, . . . . ” The display control unit 142 arranges the dish name “beef stew” and the illustration corresponding to the dish name “beef stew” in the first area of the menu screen.

An example of the process of specifying information of dishes to be arranged in the second area of the menu screen, which is performed by the display control unit 142, will be described below. The display control unit 142 selects one table ID in the user management table 133 and determines whether a Companion is present with reference to the information on whether a companion is present corresponding to the selected table ID.

When a companion is “present,” the display control unit 142 acquires the dish names arranged in the second area of the normal menu regardless of the user's allergic substance. The display control unit 142 arranges information of the acquired dish names in the second area of the menu screen. Although not illustrated in the drawing, it is assumed that information of the normal menu is registered in the storage unit 130.

When a companion is “not present,” the display control unit 142 specifies the allergic substance corresponding to the selected table ID. The display control unit 142 compares the specified allergic substance with the allergy information table 131 and specifies dish names not containing the specified allergic substance. The display control unit 142 arranges the specified dish names in the second area of the menu screen.

By selecting the table ID and performing the processes as described above, the display control unit 142 arranges the information of the dishes in the first area and the second area of the menu screen and generates the information of the menu screen. The display control unit 142 transmits the information of the menu screen to the tablet terminal 20 corresponding to the table ID.

The display control unit 142 selects the table ID and transmits the menu screen of the normal menu to the tablet terminal 20 when the allergy information corresponding to the selected table ID is not present. When all the users are determined to have the same allergy such as when users having the same allergy visit the restaurant, a menu containing the allergic substance need not to be displayed.

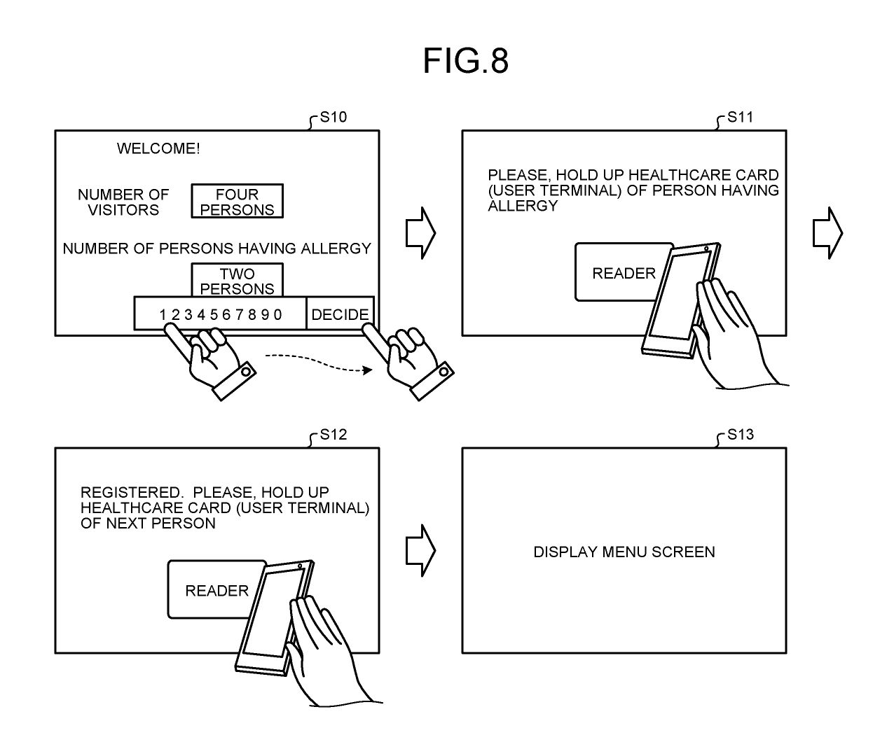

An example of transition of a screen displayed on the tablet terminal 20 according to this embodiment and the process will be described below. FIG. 8 is a diagram illustrating an example of a display screen of a tablet terminal. The tablet terminal 20 displays a question on whether a user having an allergy is present, along with the number or visitors on the display screen (step S10). In the example illustrated in FIG. 8, a blank to which the number of users having an allergy is input is displayed. When “0” is selected as the number of users having an allergy by a user, the tablet terminal 20 transmits information indicating that a user having an allergy is not present to the server 100.

When “1” or more is selected as the number of users having an allergy by a user, the tablet terminal 20 performs the process of step S11. The tablet terminal 20 displays a message requesting for holding up the user terminal 10 on the display screen. In the example illustrated in FIG. 8, a message “please, hold a healthcare card up” is displayed on the display screen. The tablet terminal 20 acquires allergy information from the user terminal 10 and transmits the acquired allergy information to the server 100 (step S11).

When “2” or more is selected as the number of users having an allergy, the tablet terminal 20 displays a message requesting for holding up a next user terminal 10a on the display screen. The tablet terminal 20 acquires allergy information from the user terminal 10 and transmits the acquired allergy information to the server 100 (step S12). The process of step S12 is repeatedly performed depending on the number of persons having an allergy.

For example, when a group includes no user having an allergy or only a person not having an allergy visits, the screen transitions in the order of steps S10 and S13, When one person having an allergy visits, the screen, transitions in the order of steps S10, S11, and S13. When a group includes a person having an allergy, the screen transitions in the order of steps S10, S11, and S13. When a group includes two persons having an allergy, the screen transitions in the order of steps S10, S11, S12, and S13. When a group includes three persons having an allergy, the screen transitions in the order of steps S10, S11, S12, S12, and S13.

The tablet terminal 20 displays the menu screen transmitted from the server 100, For example, when a user's allergic substance is “egg” and a companion is present, the menu screen illustrated in step S13a is displayed. When a user's allergic substance is “egg” and a companion is not present, the menu screen illustrated in step S13b is displayed. The menu screen illustrated in step S13a is the same as described with reference to FIG. 2. The menu screen illustrated in step S13b is the same as described with reference to FIG. 3.

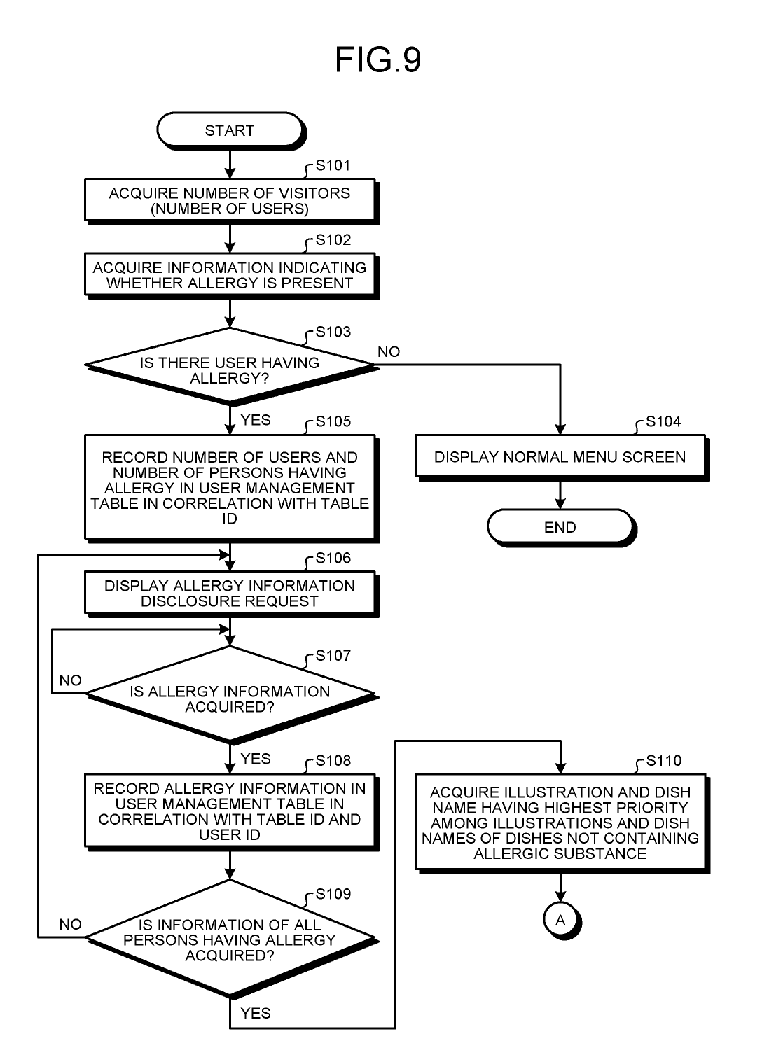

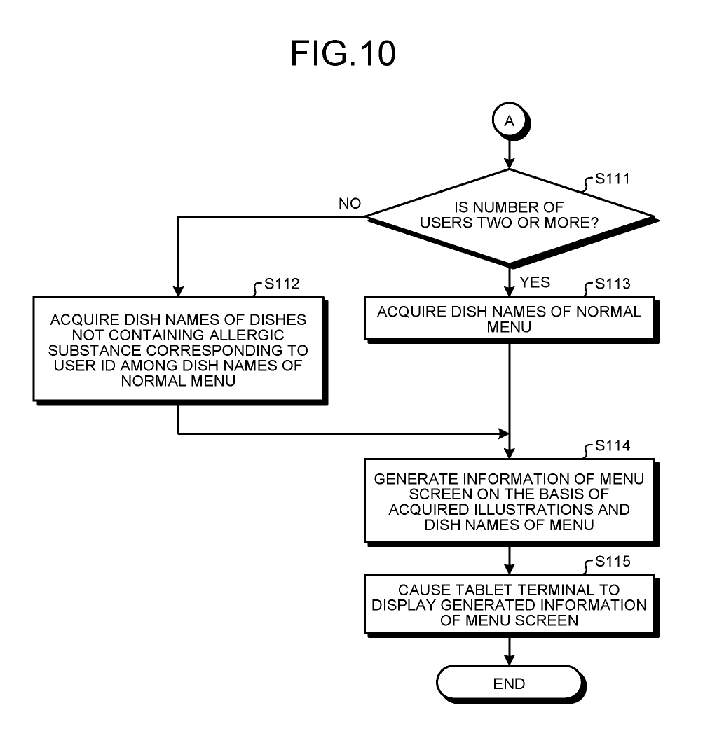

The process flow of the server 100 according to this embodiment will be described below. FIGS. 9 and 10 are flowcharts illustrating the process flow of the server according to this embodiment. The flowchart illustrated in FIG. 9 will be described. The acquisition unit 141 of the server 100 acquires the number of visitors (the number of users) (step S101). The acquisition unit 141 acquires presence of an allergy (the number of users having an allergy) from the tablet terminal 20 (step S102). When an allergy is not present (when the number of users having an allergy is zero) (NO in step S103), the display control unit 142 of the server 100 causes the tablet terminal 20 to display the normal menu screen (step S104).

On the other hand, when an allergy is present (when the number of users having an allergy is one or more) (YES in step S103), the server 100 records the number of users and the number of persons having an allergy in correlation with the table ID in the user management table 133 (step S105). The server 100 causes the tablet terminal 20 to display an allergy information disclosure request (step S106). When allergy information is not acquired (No in step S107), the acquisition unit 141 of the server 100 performs the process of step S107 again

When allergy information is acquired (YES in step S107), the acquisition unit 141 records the allergy information in the user management table in correlation with the table ID and the user ID (step S108). The acquisition unit 141 determines whether information of all the users having an allergy is acquired (step S109). When information of all the users having an allergy is not acquired (NO in step S109), the acquisition unit 141 performs the process of step S106. When information of all the users having an allergy is acquired (YES in step S109), the acquisition unit 141 performs the process of step S110.

The display control unit 142 of the server 100 acquires an illustration and a dish name having a highest priority level among the illustrations and the dish names of the dishes not containing the allergic substance (step S110), and performs the process of step S109 in FIG. 10.

FIG. 10 will be described. The display control unit 142 determines whether the number of users is two or more (step S111), When the number of users is not two or more (when a user having an allergy is present) (NO in step S111), the display control unit 142 acquires dish names of dishes not containing the allergic substance corresponding to the user ID among the dish names of the normal menu (step S112) and performs the process of step S114.

On the other hand, when the number of users is two or more (when a companion not having an allergy is present or two or more users have an allergy) (YES in step S111), the display control unit 142 acquires the dish names of the normal menu (step S113). The display control unit 142 generates information of the menu screen on the basis of the acquired illustrations and dish names of the menu (step S114). The display control unit 142 causes the tablet terminal 20 to display the generated information of the menu screen (step S115).

Advantages of the server according to this embodiment will be described below. The server 100 acquires allergy information and controls whether photographs or illustrations of products are not displayed in correlation with dish names depending on whether allergic substance corresponding to the allergy information is contained. Accordingly, according to the server 100, it is possible to display a menu screen on the basis of the allergy information.

The server 100 performs control so as not to display a photograph or an illustration of a dish containing the allergic substance corresponding to the allergy information as a recommended dish of the menu screen. Accordingly, it is possible to prevent a dish which a user having an allergy does not eat from being displayed as a recommended dish and to regard the user. The area of the menu screen in which a recommended dish is displayed corresponds to the first area.

When a user having an allergy has a companion, the server 100 performs control such that a phonograph or an illustration of a dish containing the allergic substance corresponding to the allergy information is not displayed as a recommended dish while the dish name is displayed in the same way as the normal menu. Accordingly, it is possible to regard a user having an allergy and to prevent an option of the companion from being narrowed.

The server 100 displays a photograph or an illustrating of a dish having a highest priority level among products not containing the allergic substance corresponding to the allergy information on the basis of the menu table 132 in which information of photographs or illustrations to be displayed as recommended dishes is stored. Accordingly, it is possible to display photographs or illustrations which a user having an allergy can eat as recommended dishes.

In the above-mentioned embodiment, an example in which allergy information is stored in the user terminal 10 and is read by the tablet terminal 20 is described, but the present invention is not limited to this example. A user may store allergy information in a storage medium such as an IC card and may cause the tablet terminal 20 to read the allergy information. A user may directly input allergy information to the tablet terminal 20.

The allergy information may further include methods of cooking allergic resources in addition to allergic substance. In this case, the server 100 stores groups of a dish name, allergic substance, and a cooking method in the allergy information table 131 in correlation with each other. For example, it is possible to cope with a user who is not allergic when allergic substance is “egg” but a dish is heated.

For example, it is assumed that “a dish name “rice omelet,” allergic substance “egg,” and a cooking method “heating”” and “a dish name “rice with raw egg,” allergic substance “egg,” and a cooking method “raw”” are registered in the allergy information table 131. It is also assumed that a user's allergy information includes allergic substance “egg” and a cooking method “preferably heating.” In this case, the server 100 determines that “rice omelet” can be displayed as a recommended dish to be displayed in the first area, but “rice with raw egg” is not displayed. Here, egg is exemplified, but the same is true of dishes containing other allergic substance.

In the above-mentioned embodiment, an example in which the server 100 is disposed over the network 50 and generates a menu screen is described, but the same function as the server 100 may be given to the tablet terminal 20 and the tablet terminal 20 may generate a menu screen.

An example in which the server 100 displays a recommended menu in photographs or illustrations is described, but the present invention is not limited to this example. For example, the server 100 may set a recommended menu such that a font color is conspicuous in comparison with other menus. The server 100 displays characters of a recommended menu in red with a font size of M in the first area. The server 100 displays characters of another menu in black with a font size of N in the second area. Here, M is a numeral greater than N.

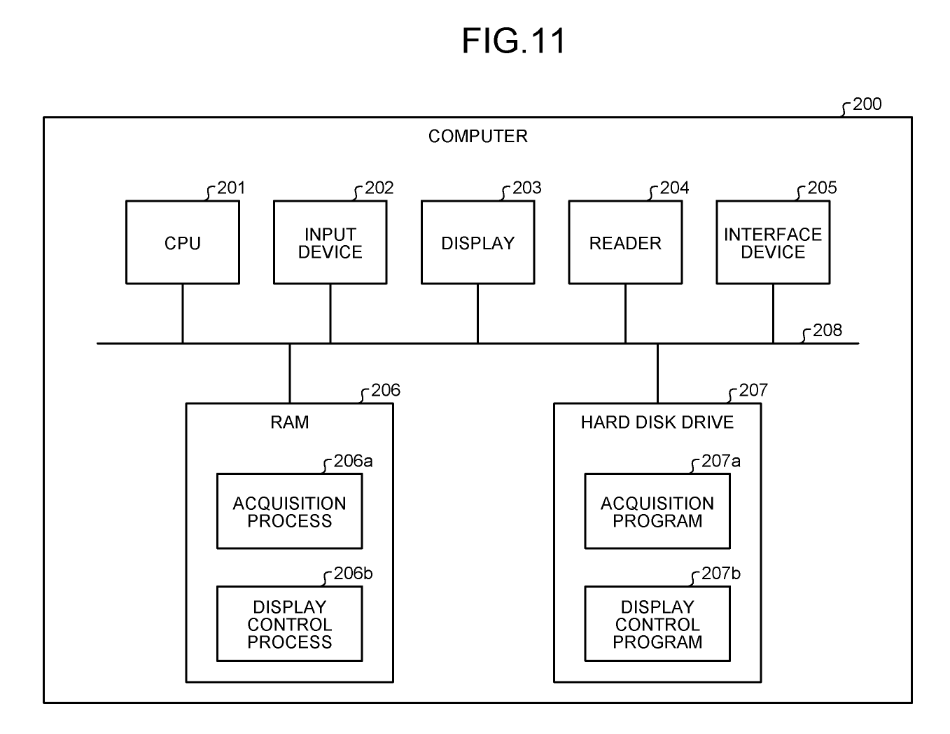

An example of a computer that executes a computer-readable recording medium for realizing the same function as the server 100 described in the above-mentioned embodiment will be described below. FIG. 11 is a diagram illustrating an example of the computer that executes a computer-readable recording medium.

As illustrated in FIG. 11, a computer 200 includes a CPU 201 that performs a computing operation, an input device 202 that receives an input of data from a user, and a display 203. The computer 200 further includes a reader 204 that reads a program or the like from a storage medium and an interface device 205 that transmits and receives data to and from another computer via a network. The computer 200 further includes a RAM 206 that temporarily stores a variety of information and a hard disk drive 207. The devices 201 to 207 are connected to a bus 208.

The hard disk drive 207 includes an acquisition program 207a and a display control program 207b. The CPU 201 reads the acquisition program 207a and the display control program 207b and loads the read programs into the RAM 206. The acquisition program 207a serves as an acquisition process 206a. The display control program 207b serves as a display control process 206b. The acquisition process 206a corresponds to the process of the acquisition unit 141. The display control process 206b corresponds to the process of the display control unit 142.

The acquisition program 207a and the display control program 207b do not have to be stored in the hard disk drive 207 at the first time. For example, the programs may be stored in a “portable physical medium” such as a flexible disk (FD), a CD-ROM, a DVD disk, a magneto-optical disk, or an IC card which is inserted into the computer 200. The computer 200 may read and execute the acquisition program 207a and the display control program 207b.

It is possible to display a menu based on allergy information.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A menu displaying method comprising;
receiving allergy information; and
controlling whether a photograph or an illustration of a product is not displayed in correlation with a name of the product to be displayed on the basis of whether the product includes an allergen corresponding; to the allergy information.

2. The menu displaying method according to claim 1, wherein the controlling does not display the photograph or the illustration when the product includes an allergen corresponding to the allergy information.

3. The menu displaying method according to claim 2, wherein the controlling displays information of the product including the allergen corresponding to the allergy information when detecting an user having an allergy and another user not having the allergy on the basis of the allergy information.

4. The menu displaying method according to claim 1, wherein the controlling displays a photograph or an illustration of the product having highest priority among products not containing the allergen corresponding to the allergy information on the basis of a table in which priority of the products and allergens contained in the products are correlated with each other.

5. A menu displaying device comprising:
a memory that stores allergy information; and
a processor operatively coupled to the memory, the processor configured to:
refer the allergy information; and
control whether a photograph or an illustration of a product is not displayed in correlation with a name of the product to be displayed on the basis of whether the product includes an allergen corresponding to the allergy information.

6. The menu displaying according to claim 5, wherein the processor is further configured not to display the photograph or the illustration when the product includes an allergen corresponding to the allergy information.

7. The menu displaying according to claim 5, wherein the processor is further configured to display information of the product including the allergen corresponding to the allergy information when detecting an user having an allergy and another user not having the allergy on the basis of the allergy information.

8. The menu displaying according to claim 5, wherein the processor is configured to display a photograph or an illustration of the product having highest priority among products not containing the allergen corresponding to the allergy information on the basis of a table in which priority of the products and allergens contained in the products are correlated with each other.

9. A non-transitory computer-readable recording medium having stored therein a program that causes a computer to execute a process comprising:
receiving allergy information; and
controlling whether a photograph or an illustration of a product is not displayed in correlation with a name of the product to be displayed on the basis of whether the product includes an allergen corresponding to the allergy information.

10. The non-transitory computer-readable recording medium according to claim 9, wherein the controlling does not display the photograph or the illustration when the product includes an allergen corresponding to the allergy information.

11. The non-transitory computer-readable recording medium according to claim 9, wherein the controlling displays information of the product including the allergen corresponding to the allergy in formation when detecting an user having an allergy and another user not having the allergy on the basis of the allergy information.

12. The non-transitory computer-readable recording medium according to claim 9, wherein the controlling displays a photograph or an illustration of the product having highest priority among products not containing the allergen corresponding to the allergy information on the basis of a table in which priority of the products and allergens contained in the products are correlated with each other.
